(19) United States
(12) Patent Application Publication
(10) Pub. No.: US 2018/0376024 A1
(43) Pub. Date: Dec. 27, 2018

(54) METHOD FOR DOWNLOADING DATA FROM MULTIPLE CAMERAS FOR OMNIDIRECTIONAL IMAGE RECORDING, AND A DEVICE FOR DOWNLOADING DATA FROM MULTIPLE CAMERAS FOR OMNIDIRECTIONAL IMAGE RECORDING

(71) Applicant: VMG ECO Sp. zo.o, Poznan (PL)

(72) Inventors: Piotr MUSZKIETA, Poznan (PL); Maciej PRZYWECKI, Kornik (PL); Krzysztof Jan WEGNER, Murowana Goslina (PL)

(21) Appl. No.: 16/052,952

(22) Filed: Aug. 2, 2018

Related U.S. Application Data
(63) Continuation-in-part of application No. PCT/PL2016/000130, filed on Nov. 25, 2016.

(30) Foreign Application Priority Data
Apr. 2, 2016 (PL) P.416742

(51) Int. Cl. H04N 1/21; G06F 3/06; H04L 29/06

(52) U.S. Cl. CPC H04N 1/2166; G06F 3/0643; G06F 13/14; G06F 3/0671; G06F 3/0604; H04L 65/4092

(57) ABSTRACT

A device and method for downloading data from multiple cameras at once for omnidirectional image recording are provided. The cameras are connected to USB ports of an integrator, whereas the charging current of the cameras is limited, then a connection is opened to the cameras and the memories made available by the individual cameras are mounted as sub-folders of a dedicated folder, after which the dedicated folder is made available and the integrator is connected to a computer and a connection is started with the integrator, where N threads are started and data is downloaded from the folders. The cameras are connected directly through USB ports to the integrator, which opens a connection with the cameras and mounts the memory resource made available by the camera as a sub-folder of the main folder, after which the main folder is made available to the user's computer through an USB port.

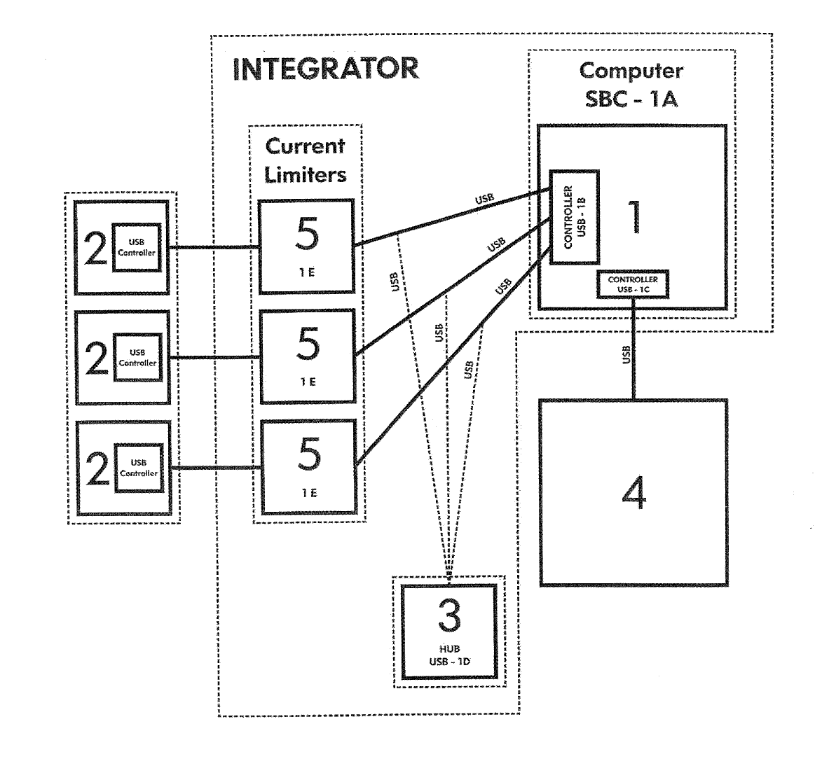

### CROSS-REFERENCE TO RELATED APPLICATIONS

The present application is a continuation-in-part of International Application No. PCT/PL2016/000130, filed on Nov. 25, 2016, presently pending.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The subject of the invention is a method for downloading data from multiple cameras for omnidirectional image recording, and a device for downloading data from multiple cameras for omnidirectional image recording, used to download the data from data from multiple cameras at once. A set of multiple cameras may create an omnidirectional camera, a multiview camera or a light field camera. A special case of such a unit is an omnidirectional camera built from action cam type video recorders, used for omnidirectional recording.

### 2. Description of Related Art Including Information Disclosed Under 37 CFR 1.97 and 37 CFR 1.98

It is known from American patent publication US 2015054913 A1 “Image stitching”, where the disclosure includes a system and method for stitching image frames. The system includes a processor and a memory storing instructions that, when executed, cause the system to: receive image frames that are captured by two or more camera modules at a particular time: interpolate a virtual camera between a first set of camera modules from the two or more camera modules: determine a set of disparity maps between the first set of camera modules; generate, based on the set of disparity maps, a virtual camera image associated with the particular time for the virtual camera from a set of image frames captured by the first set of camera modules at the particular time and construct a left panoramic image and a right panoramic image associated with the particular time from the image frames captured by the two or more camera modules and the virtual camera image.

It is known from Japanese patent JP 2003189147 A “Image pickup device and electronic device”, where has solved the problem to provide an image pickup device and an electronic device that can simply transfer information recorded in a memory card to a personal computer without cost increase and allow a plurality of video cameras to simply transfer image data with each other.

Solution is that a plurality of the video cameras are connected to the personal computer via a USB hub and image data photographed by the one video camera and stored in the memory card are easily written (copy and move) in a memory card of the other video camera without the need for using exclusive software.

In American patent publication US 2008/016312 A1 methods for managing data from removable data storage devices are described. One method may include receiving at least two removable data storage devices of a first type in a removable data storage device reader, accessing directory information for the removable data storage devices and emulating a single removable data storage device containing data folders corresponding to each removable data storage device. Another method may include determining if a memory refresh is needed for each of the received plurality of removable data storage devices and refreshing each of the plurality of memory locations in each of the plurality of removable data storage devices determined to need the memory refresh.

Fragments of the description were presented as logical operations and data processing steps performed on data bits in the memory of data processing devices, e.g. computers.

It should be understood that the logical operations and data processing steps performed on data bits in the memory of data processing devices are implemented by physical devices which perform operations and steps on physical values or operate with physical items, or their condition or conditions.

Typical physical values used to record logical information such as data bits are various forms of electric or magnetic signals, which may be stored, transferred, transmitted, combined, compared or subjected to other physical activities in a calculating system, such as a computer.

Due to their common use such signals will be called bits, packets, messages, values, symbols, signs, numbers and other names, which should be always interpreted as representations, physical values and actions performed on these physical values by physical devices. Additionally these words are used only as convenient substitutes for appropriate values and physical processes.

Names such as processing, generating, transmitting, performing, mapping, selecting, calculating, generating and others refer to physical processes and activities performed by physical devices (processing systems) which operate on data and transform data, represented by physical (electrical) signals in the records and memory of a processing system into other data which are also represented by physical values in the records and memory of the processing system or other data storage system using physical values.

The computer memory, memory, data card typically refer to a device which enables the storage of a set of states (information, data bits) in the form of electrical signals or changes to other physical state of this device and enables the multiple measurements of this condition (reading the information, data, bits).

The sets of cameras are frequently constructed from relatively cheap and mass produced “action cam” type cameras. An example of such camera is the GoPro Hero 3 Black camera. These cameras record a moving image in a built-in internal memory or as in the case of the mentioned earlier GoPro camera, on a memory card entered in an appropriate slot in the camera.

The cameras may record the images or video on a memory card such as the SD card [https://en.wikipedia.org/wiki/Secure_Digital], miniSD or microSD [http://www.dtt8.com/images/micro-sd%20specification.pdf] standard.

Another popular memory card standard used in cameras is the MMC standard [http://www.jedec.org/sites/default/files/docs/JESD84-B41.pdf]. Some cameras use CF memory cards [http://www.compactflash.org/].

The cameras are equipped with an Universal Serial Bus (USB) [https://p1.wikipedia.org/wiki/USB] and a computer connector (port or interface) compatible with the USB standard used to connect the camera to other devices.

The USB architecture consists of an USB host, multiple USB ports and connected devices. The USB host may manage multiple controllers, and each controller may make one or more USB ports available. These devices may be connected creating a tree topology network by using USB hubs. They may be cascade-connected, creating an up to five level tree structure. The entire network may be used to connect up to 127 USB devices, however due to the power draw their number has to be limited. Each device communicates with the controller using up to 32 logic channels, of which 16 are input channels and 16 output channels. Two channels, one for each transmission direction are reserved, so there are 30 actual logic channels per each connected USB device. A single USB network may be used by devices with various transmission speeds.

USB standard compatible devices may be divided into three groups for reasons of compatibility with the assumed USB standard specifications:
USB 1.1 standard compatible devices; devices which meet the conditions for this specification may operate at (Full Speed) 12 Mbit/s (1.5 MB/s) and (Low Speed) 1.5 Mbit/s (0.1875 MB/s).
USB 2.0 (Hi-Speed) standard compatible devices; devices which are compatible with the USB 2.0 specification can transmit data at a maximum rate of 480 Mbit/s (60 MB/s). Actual data transmission rate depends on the device design and according to independent tests conducted by the CNet website [http://www.cnet.com/products/seagate-freeagent-goflex-ultra-portable/2]the maximum write speed is in the range of 25 to 30 MB/s, and read speed from 30 to 42 MB/s. The USB 2.0 standard devices are fully compatible with the older standard devices.

Most of the cameras available on the market, in particular “action cam” type cameras are devices compatible with USB 1.1 or USB 2.0 standard, however the data transmission rate is limited to 10 MB/s [http://www.goprofanatics.com/forum/gopro-hd-hero3/2496-usb-transfer-rate.html].

To accelerate the downloading of data recorded by the camera, usually the memory card is removed from the camera and the data is read directly by a memory card reader instead of connecting the camera to the computer by an USB. For example the use of dedicated card readers enables the reading of data from an SD memory card at a speed of 20 MB/s in case of an USB 2.0 compatible memory card reader [https://www.pugetsystems.com/labs/articles/Card-Reader-Comparison-USB-2-0-vs-USB-3-0-126/].

The USB in the cameras is also used for device charging. Standard power supply voltage for a single USB 1.1 or 2.0 compatible device is 5 V, whereas the specification defines conformance range of 4.75 V to 5.25 V [http://www.usb.org/developers/docs/usb20_docs/]. For USB 2.0 port the basic power supply unit is 100 mA, and these are the minimum values of the current which may be supplied by the port. At a standard power supply voltage the current in the circuit is 5 times higher and reaches 500 mA.

The USB specification in 2007 defined a new type of ports used for the charging of device batteries, called charging ports. They enable obtaining supply currents exceeding 500 mA without any negotiations with the controller, due to the possibility of interference the maximum supply current was limited to 900 mA. Whereas for dedicated charging ports the maximum current value which may be supplied by the port reaches 1.5 A.

Regardless of the USB standard version, the specification defines a series of USB device classes [http://www.usb.org/developers/docs/devclass_docs/] which specifies the details for communication with a given class of a device. One of the classes is a Mass Storage Class [https://en.wikipedia.org/wiki/USB_mass_storage_device_class] commonly used in mass storage and pendrive devices. A mass storage class device provides access to its internal memory to the host device to which it is connected, enabling the host device to operate directly on the data recorded in the internal memory of the mass storage class device in the same manner as on data recorded directly in the host device memory.

Memory which is made available by mass storage class devices is mounted, that is, logically connected, and makes available the file system recorded in the memory, which is manipulated by the operating system. Logically mounted memory is made available as a contents of the folder where it was mounted.

The operating system [https://en.wikipedia.org/wiki/Operating_system] is software for the management of a computer system (processing unit), which generates a logical environment to start and control user tasks which are executed by the system.

Thread should be understood as a part of the computer software which is executed by the computer (processing unit) concurrently with other tasks performed by the computer. Usually each thread is executed by a different hardware fragment of the computer's processor, a different processor core.

The term “data downloading” should be understood as the process of copying and transfer of information between the memory of one device and the memory of another device.

Simultaneous operation of multiple cameras installed in a common holder or set of holders generates significant problems related to the downloading of the data recorded by the camera to a single computer or mass storage device, such as a RAID. In particular the significant problems include:
the need of removing the memory cards from cameras before downloading
subsequent connections of all cameras from the set to a computer or a mass storage device in case of cameras with no replaceable memory cards (built in memory)
the need to charge the camera batteries before commencing the download of data (using the USB port)
time needed to copy the data from all of cameras.

The device according to the invention enables the copying of data from all the cameras of the set without necessity of removing the cameras from the grip or set of grips every time, nor to remove memory cards from the cameras. A method according to the invention enables the shortening of the time needed to download the data from a set of cameras to a computer or mass storage device compared to the downloading (transmission) of data from cameras through an USB to a computer.

Currently downloading the data from a set of multiple cameras usually requires removing the memory card from each camera and to laboriously read their data one after another. Typically the download is performed by connecting cameras in a sequence to a computer through an USB and downloading the data, or by removing data cards from the cameras and reading the memory cards using dedicated card readers [https://en.wikipedia.org/wiki/Card_reader].

There are devices on the market which are based on USB hubs, which enable connecting 4 to 10 card readers to the computer, eliminating the need for arduous swapping of memory cards and enable the simultaneous connection of 4 to 10 memory cards to the computer.

Another popular solution for the problem of downloading data from multiple cameras is the use of an USB hub and/or many USB hosts, enabling the connection of multiple cameras to the computer. In this case multiple devices or mass storage devices are visible to the computer operating system, enabling the downloading (copying) of data from connected cameras. This solution requires a sequential initiation of connections (logical connections at the operating system level) with subsequent cameras in order to download the data recorded by the cameras.

### BRIEF SUMMARY OF THE INVENTION

The essence of the invention which is a device for downloading data from multiple cameras for recording an omnidirectional image, equipped with an integrator, composed of the SBC-1A computer, two USB controllers (1B and 1C), hub USB-1D and current limiters 1E, consists in the fact that a set of cameras (2) being connected in parallel directly through USB (4) cables to the integrator (1), whereas each of the cameras (2) is connected directly through USB 3 cables to the USB-1D hub for direct recording of memory resources of each of the cameras (2) as a sub-folders (3) of the dedicated folder of the integrator (1) in the form of “mass storage” type storage through an USB cable connected, to the user's computer USB port (4), which supplies the entire integrator system (1) through current limiters 1E (5), placed between the integrator (1) and cameras (2).

Since the device connected to the user's computer may draw only a limited amount of current (typically the USB controller supplies 2 A of current at a voltage of 5 V), the device uses a system of current limiters, which reduces the maximum current draw by the cameras connected to the device.

The essence of the invention, which is a method for downloading of data from multiple cameras for the recording of an omnidirectional image through an integrator operating in a system composed of an SBC-1A computer, hub USB-1D and current limiters 1E, consists of each of the cameras (2) are connected in parallel to USB ports of the integrator (1), whereas the charging current of each of the cameras (2) is limited by current limiters 1E (5), then a connection being opened to each of the cameras (2) connected directly to the USB-1D hub and the memories made available by individual cameras (2) are mounted as sub-folders (3) of a dedicated folder of the integrator (1), after which the dedicated folder with mapped memories from individual cameras as sub-folders (3) is made available as a “mass-storage” type USB device to a user's computer's connected to USB port (4) through USB cable and a connection is thus started from a user's computer with the integrator (1), for parallel downloading of data from multiple cameras (2) in an amount of N threads, where data are downloaded directly from the mapped by the integrator (1) memory of the connected cameras (2).

It is advantageous when the number of cameras connected to the integrator is higher than the amount of started threads.

It is also advantageous when the number of started threads equals 1.

It is also advantageous when the memories made available by individual cameras are mounted as sub-folders of a dedicated folder with names which unequivocally identify the number of the connected camera.

It is also advantageous when the memories made available by individual cameras are mounted as sub-folders of a dedicated folder with names which unequivocally identify the number of USB port to which the given camera was connected.

This method is implemented in a device for downloading data from multiple cameras according to the invention, the essence of which consists of a set of cameras being connected directly through USB ports to an integrator, which opens a connection with each of the cameras and mounts the memory resource which is made available by the camera as a sub-folder of the main folder, after which the main folder with mapped sub-folders is made available to the user's computer through an USB port.

It is advantageous when current limiters are installed in the USB line between the integrator and the cameras.

The use of the solution presented in the invention enables the following technical and utility effects:
the possibility of simultaneous reading of images from multiple cameras without having to remove a memory card from the camera,
limiting the maximum current supplied to the cameras by the user's computer,
increasing the camera system's data download speed,
the problem of simultaneous downloading of data from a set of multiple cameras was solved, while powering the system solely from the user's computer USB port.

### BRIEF DESCRIPTION OF THE DRAWINGS

The subject of the invention, in an example, but not limiting, implementation is presented in diagram form on the single attached FIGURE.

### DETAILED DESCRIPTION OF THE INVENTION

A device according to the invention described above is an integrator 1 composed of an SBC (single board computer) 1A, two USB controller (1B and 1C), hub 1D and current limiters 1E. The cameras 2 are connected directly to the hub 1D using the USB cable 3. The integrator 1 software executed by the processor of the SBC computer 1A opens a connection to each of the cameras 2 and mounts the memory resource made available by the camera 2 as a sub-folder 3 of a separate folder 4 (drawing of the memory system). There is a possibility where each of the sub-folders identifies in an unequivocal manner the number of the camera, which enables simple processing of data recorded by individual cameras on subsequent stages of processing.

The integrator 1 makes available the main shared folder 4 with the mapped sub-folders 3 as a mass storage device, through a controller 1C and an USB connection 5 to the user's computer 4 to which it was connected.

Since the integrator connected to the computer may draw only a limited amount of current (typically the USB controllers allows the drawing of up to 2 A of current at 5 V). Moreover typically the camera 2 when connected to a computer or another device with an USB connector tries to switch to a charging mode and requests a large charging current (typically 750-900 mA). In case of connection of N cameras to the integrator 1 the total current required by cameras 2 would amount to N×the current requested by a single camera, while the integrator 1 may draw from the user's computer 4 a current which allows only to supply only a single camera (a max. of 2 A at 5 V). To solve this problem in the integrator 1 between the USB hub 1D and the cameras 2 current limiters 1E were placed, which limit the maximum current supplied to cameras 2.

We claim:

1. A method for downloading of data from multiple cameras for the recording of an omnidirectional image through an integrator operating in a system composed of a computer, two USB controllers, a USB hub and current limiters, characterized in that each of the cameras are connected in parallel to USB ports of the integrator, whereas the charging current of each of the cameras is limited by current limiters, then a connection being opened to each of the cameras connected directly to the USB hub and the memories made available by individual cameras are mounted as sub-folders of a dedicated folder of the integrator, after which the dedicated folder with mapped memories from individual cameras as sub-folders is made available as a “mass-storage” type USB device to a user's computer connected to USB port through USB cable and a connection is thus started from a user's computer with the integrator, for parallel downloading of data from multiple cameras in an amount of N threads, where data are downloaded directly from the mapped by the integrator memory of the connected cameras.

2. The method according to claim 1, wherein the number of the cameras connected to the integrator is higher than the number of started threads.

3. The method according to claim 1, characterized in that the number of started threads equals 1.

4. The method according to claim 1, wherein the memory resources made available by individual cameras are mounted as sub-folders of a dedicated folder with names which unequivocally identify the number of the connected camera.

5. The method according to claim 1, wherein the memories made available by individual cameras are mounted as sub-folders of a dedicated folder with names which unequivocally identify the number of the USB port to which the given camera was connected.

6. A device for downloading data from multiple cameras for recording an omnidirectional image, equipped with an integrator, composed of a computer, two USB controllers, a USB hub and current limiters, characterized in that a set of cameras being connected in parallel directly through USB cables ports to an the integrator, whereas each of the cameras is connected directly through USB cables to the USB hub for direct recording of memory resources of each of the cameras as sub-folders of the dedicated folder of the integrator in the form of “mass storage” type storage through a USB cable connected to the user's computer USB port, which supplies the entire integrator system through current limiters, placed between the integrator and cameras.
